(19) United States
(12) Patent Application Publication
(10) Pub. No.: US 2003/0029296 A1
(43) Pub. Date: Feb. 13, 2003

(54) Sound dampened ceramic clad diamond saw blade

(76) Inventor: Luigi Donazzan, Romano D'Ezzelino (IT)

Correspondence Address: Mr. Keith K. Nicolls; McCaleb, Lucas & Brugman, Court C, One South 376 Summit Avenue, Oakbrook Terrace, IL, 60181, US

(21) Appl. No.: 09/928,808

(22) Filed: Aug. 13, 2001

(51) Int. Cl. B23D 57/00

(52) U.S. Cl. 83/835

(57) ABSTRACT

An improved diamond tipped saw blade for cutting stone, concrete and similar materials having an innovative laminated core structure of metal and ceramic fiber material arranged to reduce operating noise, increase resistance to heat and significantly increase blade strength and wearability. Importantly, an innovative welding process is employed for attaching diamond cutting segments to the core thereby materially enhancing cutting performance of the blade and permitting replacement of worn cutting segments. Modifications of the aforedescribed blade structure are disclosed setting forth alternative structure of parts.

This invention concerns an improved diamond tipped saw blade exhibiting improved blade life and operational characteristics.

### BACKGROUND OF THE INVENTION

A traditional diamond blade for cutting stone, concrete or metal, for example, is made up of a metal disc forming a circular core plate and a plurality of diamond cutting tips (usually arcuate segments) welded about the circumference of the core plate; the several cutting tip segments being circumferentially spaced by radially extending slotted openings cut in the periphery of the core plate. The core plate is usually made of low carbon steel while the diamond tips are conventionally obtained by hot pressing metal powder mixed with diamond crystals into desired shape according to known practice. Attaching cutting tips to the core plate is usually carried out by brazing or laser welding. Brazing is performed by heating and interposing melted silver based alloy between the cutting tip and the core plate, When cooled, this provides a proper attachment system. Usually hard steel (46-48 HRC) is used to provide a metal disc to be brazed as above noted. However, water cooling of the saw blade during cutting operation is normally employed to avoid excessive blade temperatures sufficient to melt the brazing alloy. Laser welding does not require any welding or brazing alloy, even during dry cutting operating conditions, but does require a low carbon steel core plate (38 HRC) and a diamond free base zone in the cutting segments plus accurate radial mating of the segments and core plate.

In general, diamond blades currently available are featured by excessive operating noise; caused by major vibration resulting from cutting tip impact with the material being cut. If a dry cutting is required, then a laser welded blade must be used. This is more expensive and because low carbon steel is used in the core plate, frequent core failure and reduced performance follows.

### BRIEF SUMMARY OF INVENTION

In brief, this invention concerns an improved diamond cutting saw blade structure comprising a base core and diamond tips fixed to the core embodying features productive of a noticeable reduction in operational blade noise and a marked prolonging of blade life. Interconnection of the base core and the cutting tips preferably is carried out by a welding system uniquely fitted to the interjoining of a the diamond tip material to the base core.

It is an important object of this invention to provide a novel diamond cutting blade of improved operating characteristics and durability.

It is another object of this invention to provide a diamond tip saw blade having a novel composite core plate of increased strength and heat resistance.

Another important object of this invention is to provide a diamond tip saw blade having a central core plate supporting a plurality of diamond cutting tip segments arranged to be welded to the core plate by capacitive discharge process.

Still another important object of this invention is to provide a diamond tip saw blade according to the immediately preceding object in which the core plate is of high carbon steel capable of dry cutting operation without operational failure.

A further object of this invention is to provide a diamond tip saw blade in which the diamond cutting material is joined to a metal core by capacitive discharge welding which permits replacement of worn diamond materials.

Having described this invention, the above and further objects, features and advantages thereof will be recognized by those skilled in the related art and with reference to the illustrative embodiments set forth in the accompanying drawings.

In the drawings:

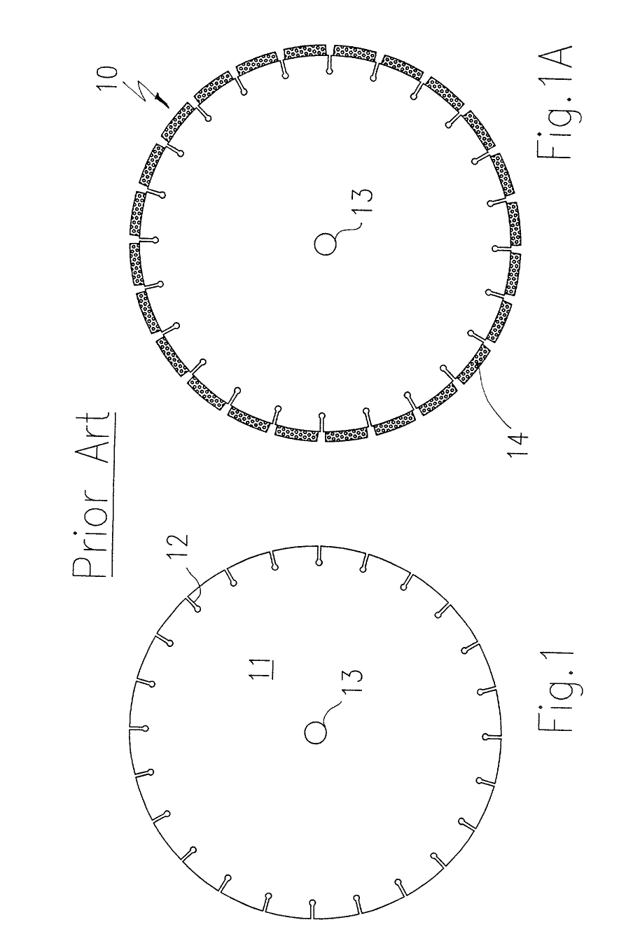

FIGS. 1 and 1A are front elevations of typical prior art diamond saw blade assemblies;

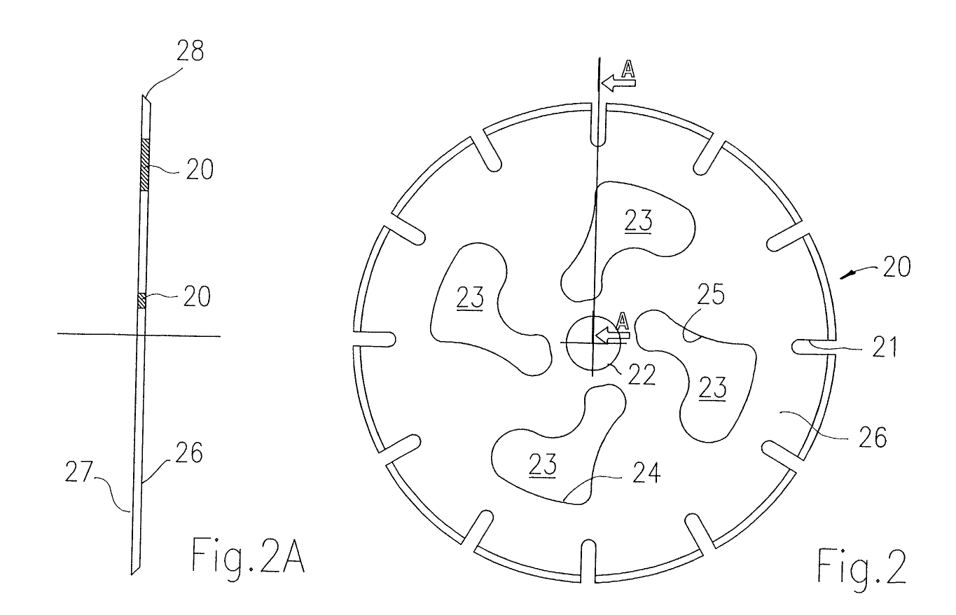

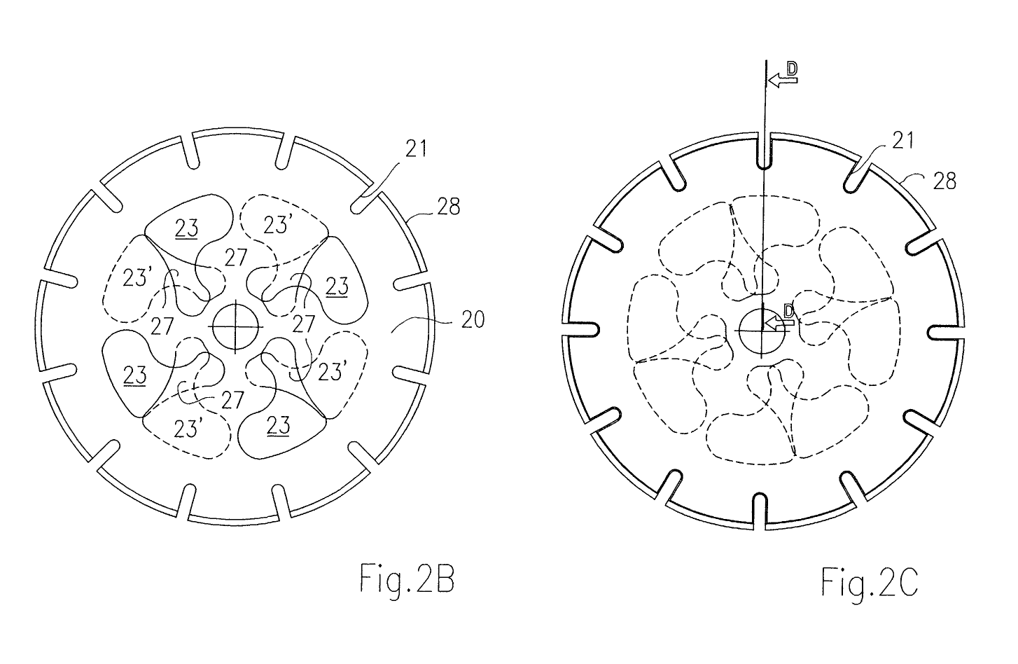

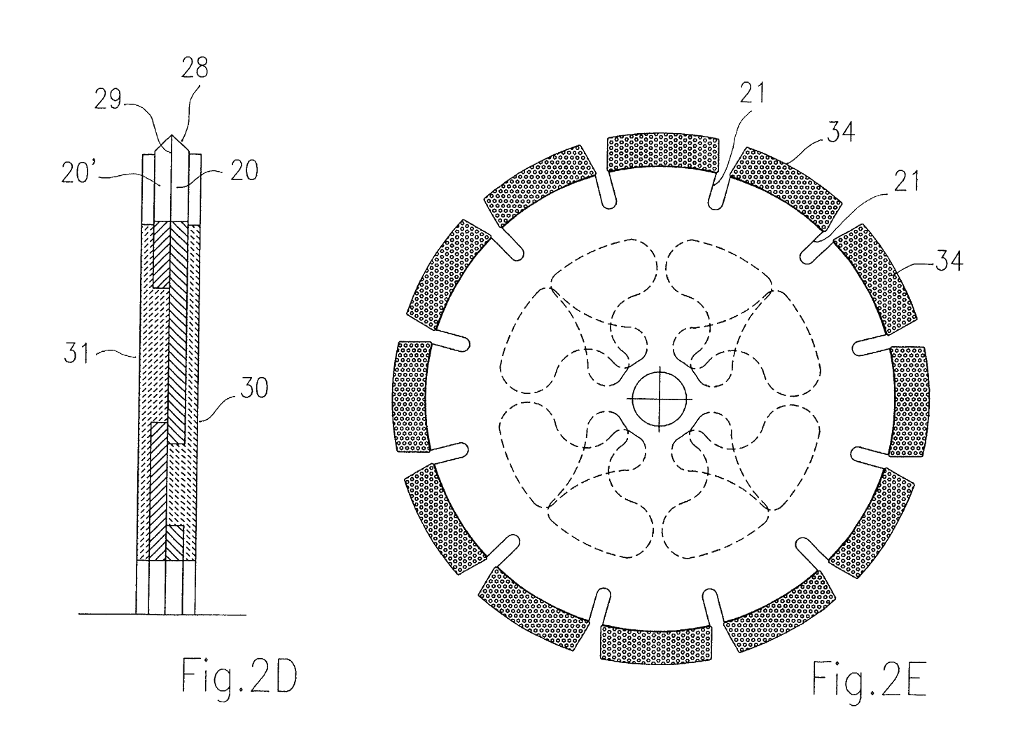

FIG. 2 is a front elevation of single metal disc with free form openings according to this invention;

FIG. 2A is a side elevation of the disc show in FIG. 2 with portions broken away in section along vantage line A-A of FIG. 2;

FIG. 2B is a front elevation of a metal disc as shown in FIG. 2, which has been interconnected, back-to-back with a second like disc;

FIG. 2C is a front elevation of the two interjoined discs of FIG. 2B in which the outer faces of the metal discs have been coated with layers of ceramic fiber;

FIG. 2D is a partial enlarged cross section of the assembled discs shown in FIG. 2C, taken along vantage line D-D of FIG. 2C and looking in the direction of the arrows thereon;

FIG. 2E is a front elevation of the assembly shown in FIGS. 2C and 2D with diamond segments fixed to the periphery of the assembly;

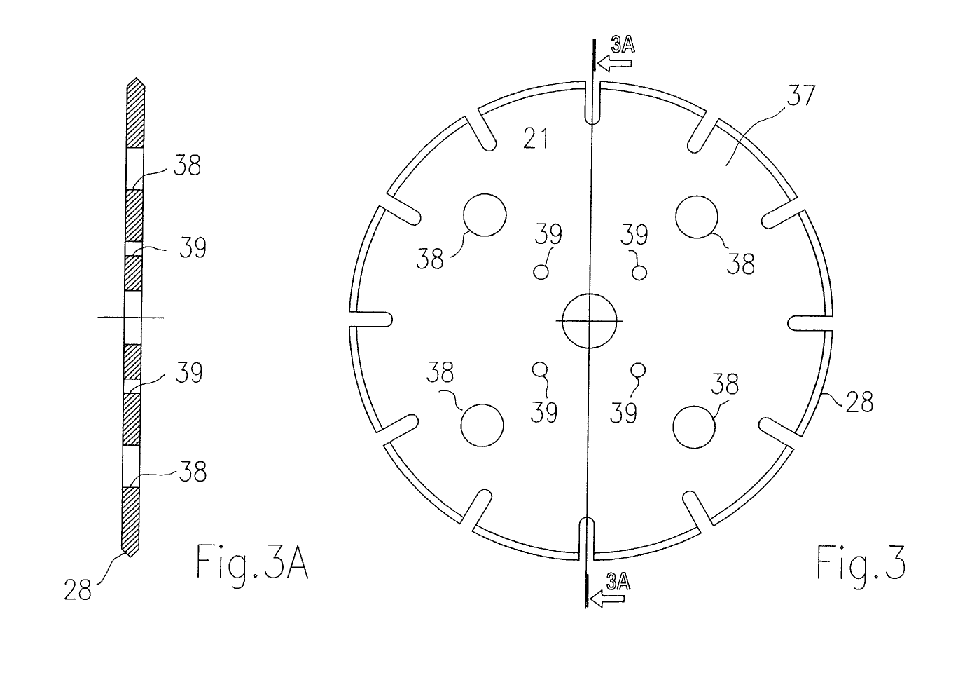

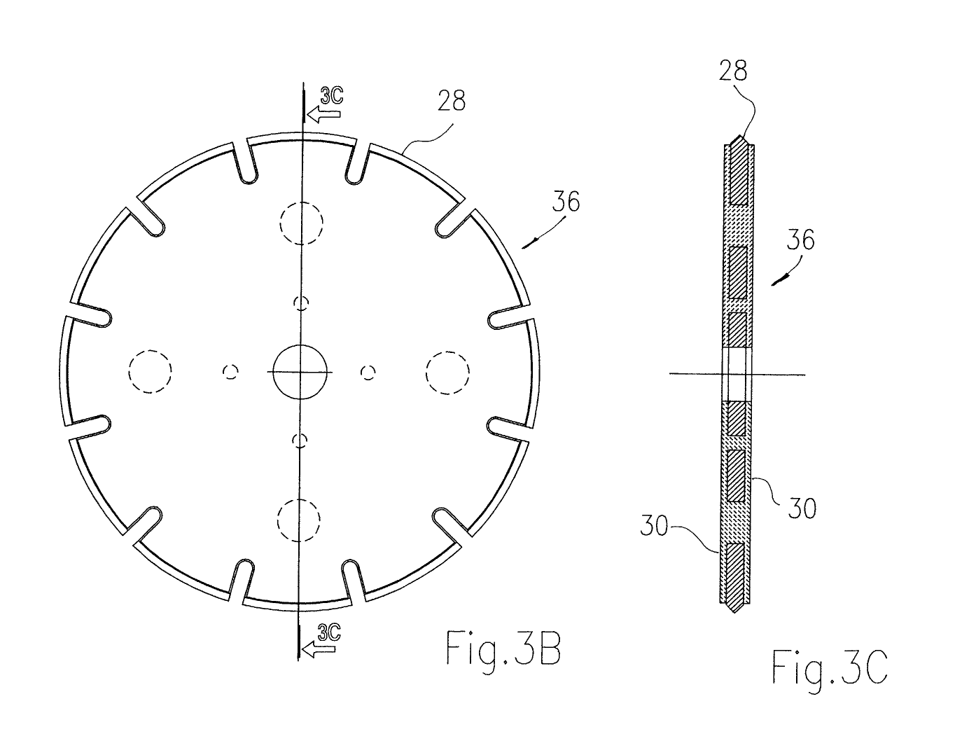

FIG. 3 is a front elevation of modified metal core disc;

FIG. 3A is a full cross section of the disc shown in FIG. 3 taken substantially along vantage line A-A looking in the direction of the arrows thereon;

FIG. 3B is a front elevation of a pair of metal core discs as shown in FIG. 3 interjoined back-to-back and having outside surfaces covered with ceramic;

FIG. 3C is a full cross section of the core disc structure shown in FIG. 3B, as viewed substantially along vantage line C-C of FIG. 3B.

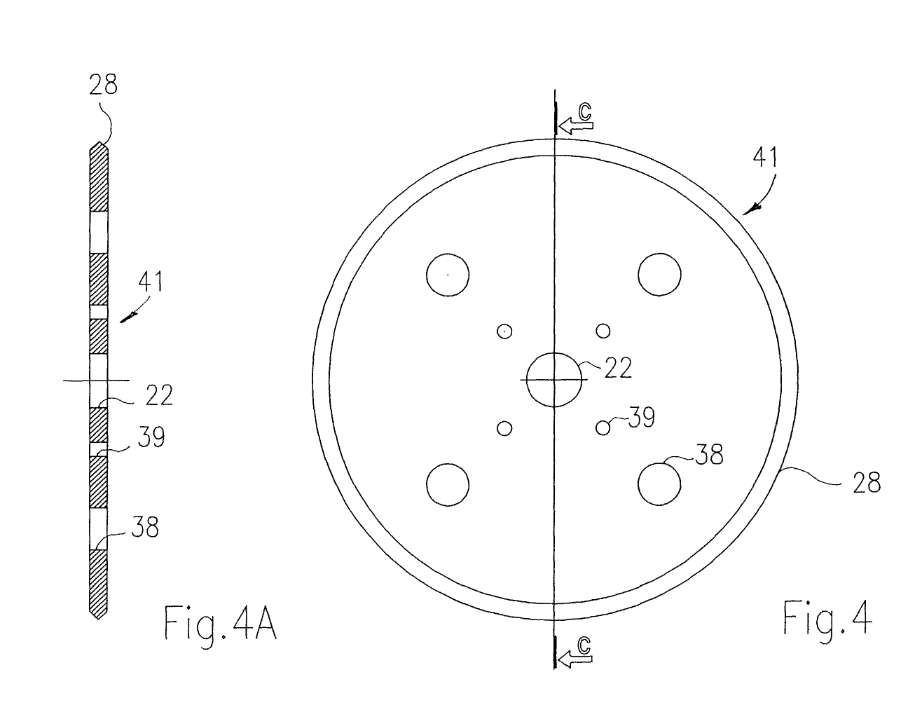

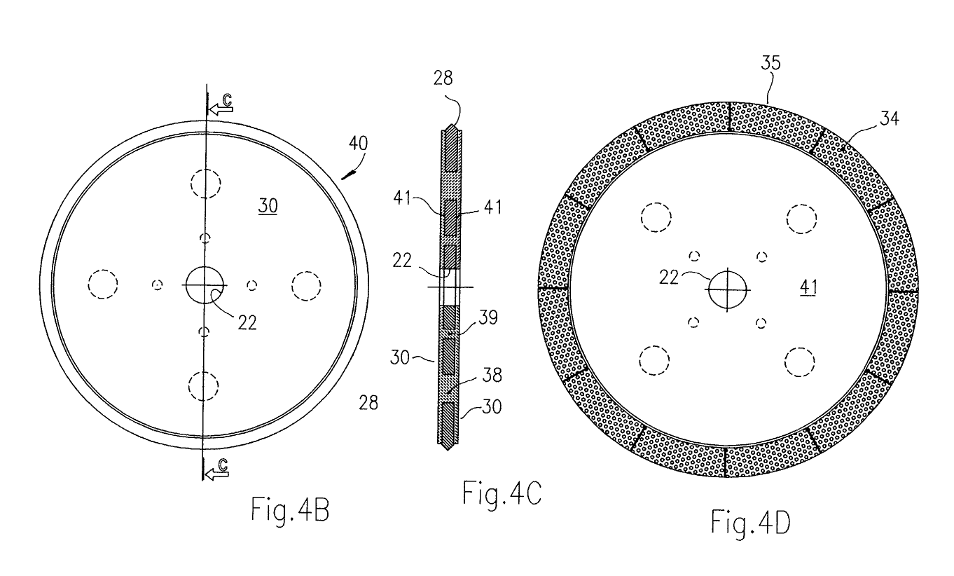

FIG. 4 is a front elevation of a second modified metal core disc similar to the FIG. 3 embodiment;

FIG. 4A is a full cross section of the disc shown in FIG. 4, taken along vantage line C-C of FIG. 4 and looking in the direction of the arrows thereon;

FIG. 4B is a side elevation of the metal core disc shown in FIG. 4, with opposite faces thereof covered with ceramic;

FIG. 4C is a full cross section of the disc assembly shown in FIG. 4B, taken along vantage line D-D of FIG. 4B and looking in the direction of the arrows thereon;

FIG. 4D is a front elevation of a completed saw blade assembly in which abrasive cutting material is mounted along the periphery of the core disc assembly shown in FIG. 4B;

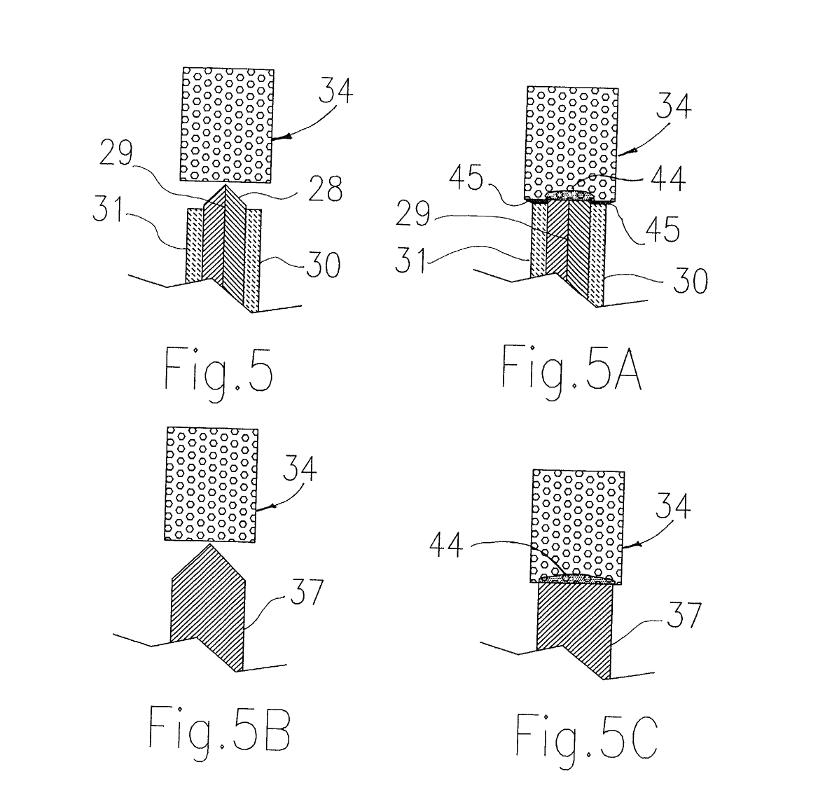

FIGS. 5 and 5A-5C are schematic partial cross sections of the core disc assemblies described heretofore to illustrate a system for attaching the abrasive cutting material to the periphery of the metal core disc assemblies.

### DESCRIPTION OF THE PREFERRED EMBODIMENT

Turning now to the prior art saw blade 10 illustrated in FIG. 1A, it will be understood the such known structures embody a single, planar circular metal core disc 11 having a plurality of circumferential slots 12 extending radially inward from the periphery of disc 11. A central opening 13 is provided for receiving a shaft for rotatability driving blade 10.

As previously noted, the core disc usually is made from hardened steel (46-48 HRC) and the segments 14 usually are attached to the steel disc by laser welding or brazing under present practice.

If the diamond segments are to be laser welded to the core disc, the latter is made of low carbon steel (38 HRC) and the diamond segments must have a diamond free base or backing. Accurate radial alignment of the diamond segments on the core disc is necessary.

A preferred embodiment of this invention is illustrated in FIGS. 2 through 2E.

As shown therein, the base core of the improved saw blade of this invention comprises a planar, circular metal (usually steel) body plate 20 having a plurality of circumferentially spaced slotted openings 21 at its out periphery and a central circular opening 22 receptive of a drive shaft (not shown) and distinguished by four free-form (generally P shaped) like openings 23 oriented one in each quadrant of the circular body plate comprising an enlarged end portion 24 located radially outward of a contiguous, elongated stem portion 25.

It will be noted that the outer peripheral edge of body 20 is beveled angularly at approximately 45° from the outer face 26 toward the opposite face 27 of plate 20 (see FIG. 2A). This beveled formation provides one half of a V shaped rim 28 for the assembled core, as will appear presently.

In FIGS. 2B and 2D, it is seen that the single body plate 20 has been coupled to a second body plate 20′ in mirror reflection to form a sandwich wherein opposing openings 23 and 23′ of plates 20, 20′ overlap and partially communicate with one another at areas 27. Adhering the two core plates together is carried out by a resinous material or an optional intervening Teflon layer 29, best shown in FIG. 2D.

When fully assembled, the core body has its opposite faces covered by a relatively thick coating of ceramic fiber material such as Nextel fiber 610 made by 3M. This material is basically categorized as OXIDE-OXIDE Ceramic Matrix composite laminate characterized by outstanding capability to withstand heat and resist abrasion.

The ceramic matrix is molded over opposite faces of the core body and hardened in position. In this procedure, the several P shaped openings are filled with ceramic material which flows through and fills the communicating areas 27 to interlock the two metal plates 20 and 20′. The ceramic layers are indicated at 30 and 31 (see FIG. 2D).

While it is preferable to mold the ceramic with the base plate assembly, it is also possible to cut ceramic sheet material to provide cover plates 30 and 31 as well as P shaped members to fill openings 23 and 23′. Such ceramic members are then glued in place and integrated with the base plates by high temperature resistant glue such as General Electric RTV Silicon having a temperature range of 45° to 500° F. and viscosity of 25,000 GPS.

Once the laminated core assembly is completed, attachment of diamond tips or abrasive cutting members 34 to the outer rim of the body core plates 20, 20′ may be carried out. In the herein illustrated case, the diamond tips 34 are formed as arcuate segments to be attached to the V shaped rim sectors between the slot openings 21. Preferably, this is accomplished by welding the diamond segments 34 over the outer ends of the body core rim segments as will be described in greater detail hereinafter.

Turning now to the modified core body 36 shown in FIGS. 3B and 3C of the drawings, it will be noted from FIGS. 3 and 3A that a single metal core disc 37 is employed. Disc 37 is distinguished by four circular holes 38 and four smaller holes 39 aligned in diametrically opposite pairs of the two size openings so as to be disposed one such pair in each quadrant of the circular disc 37. Like the core body of FIGS. 2-2E, disc 37 is provided with radial slotted openings 21 extending inwardly of its circumference and a V shaped rim 28 along its periphery.

Core disc 37 has its opposite faces overcovered with layers of ceramic material as previously described; the ceramic being molded in place or, alternatively, cut from sheet material and glued to opposite side faces of disc 37. This provides a structure ready for attachment of diamond tip segments, as in the previously described blade of FIGS. 2-2E.

In FIGS. 4-4C, another modified core body 40 is shown (see FIG. 4B) which like the FIG. 3 embodiment described above, has a single core plate 41. Openings 38, 39 and central shaft receptive opening 22 as previously described are present in plate 41. Also, a V shaped rim 28, as in the FIGS. 2 and 3 embodiments is employed for the plate 41 structure. Opposite faces of plate 41 are, as in the FIG. 3 embodiment, covered with ceramic material layers 30, as previously described (see FIGS. 4B and 4C). This core body 40 is designed to carry diamond cutting material on its periphery. When the body structure shown in FIGS. 4B and 4C is employed, then the diamond material is cut in segments 34, that in this case are abuttingly arranged to effectively present an unbroken diamond cutting band to form a turbo-like blade.

It is also contemplated that in some instance, it may be desirable to provide the core body with a single piece or unitary annular cutting band which would require eliminating the V rim 38 and brazing the diamond ring to the metal/ceramic body structure.

As in the previously described embodiments, attachment of the diamond material to the core body in embodiment of FIG. 4D preferably is by welding as will be explained more fully presently.

Turning now to FIGS. 5-5C, the welding of diamond cutting material to a variety of core body configurations is illustrated.

As seen in FIG. 5, a diamond cutting member 34 is positioned to contact the apex of the V shaped rim 38 of the core body having two metal plates 20, 20′ laminated between a pair of ceramic layers 30, 31 (see FIGS. 2-2E).

While conventional welding technologies such as resistance welding, laser, plasma, TIG, etc. have been used with fair success in the art of fabricating diamond saw blades, this invention adopts a formerly undiscovered use of an old welding procedure called Capacitive Discharge Welding (CDW) or High Energy Impulse Welding to the art of diamond saw blade manufacture.

In this procedure, high amp current is directed through parts to be joined together. The welding takes place due to the heat developed in the highest resistance point which occurs at the point or areas of contact between two parts. Only recently has progress in electronic technology provided welding equipment capable of delivering high energy in a fraction of a second with the capability of delivering and controlling both energy and time.

One big difference between resistance welding and Capacitive Discharge Welding lies in the fact that energy flow in CDW procedure is accumulated in a capacitor and delivered as a train of metered and timing controlled impulses whereas in resistance welding, energy flows through the parts to be joined.

Applying CDW procedure to diamond tool art is possible only if a high electric resistance contact is created between parts to be united. This is accomplished by providing a sharp V contact either on the rim of the metal core to engage a flat surface on the diamond material or vice versa. This relation is shown in FIG. 5.

Pressing force up to 6,000 lbs. between parts is used before releasing the CDW impulse. Usually one part is moved and the other part held stationary during the instantaneous melting process which occurs.

The result of the CDW procedure for joining the diamond material with the metal core body is indicated at the melted weld zone 44 in FIG. 5B. Resin or glue 45 is employed to fill any gap between the ceramic and diamond material after weld 44 is completed.

Likewise, CDW welding may be carried out successfully between a diamond segment and a single or double metal core, as in FIGS. 5A and 5B.

With the use of CDW welding procedure, it is quite possible to remove a worn diamond segment and replace it with a new, unworn segment. This is not particularly practical with other known welding or brazing procedures.

From the foregoing, it is believed that those skilled in the art will readily recognize the improved advancement in the art afforded by this invention and that while preferred and modified embodiments illustrated in the drawings have been described in relation to certain procedures and materials, it will be appreciated that multiple changes, modifications and substitution of equivalents may be resorted to without departing from the spirit and scope of this invention which is intended to be unlimited by the foregoing except as may appear in the following appended claims

I claim:

1. A vibration damping diamond tip saw blade, comprising:
a base core having a planar metal body provided with plural spaced openings;
a sharply pointed rim extending radially from the periphery of said body and heat resistant ceramic material laminated over planar faces of said body.

2. The saw blade of claim 1, wherein said ceramic material fills some of said openings to effectively interlock said ceramic material and said body.

3. The saw blade of claim 1, wherein said ceramic material is cut from sheet material to provide planar parts for covering said faces of said body, additional parts for filling said some of said openings, and means securing said parts and said additional parts to said body and to one another.

4. The saw blade of claim 1, wherein said metal body comprises a pair of metal discs laminated together with the periphery of each said disc defining one half of said rim.

5. The saw blade of claim 1, wherein said some of said openings in said metal body are generally free form P shape.

6. The saw blade of claim 1 and at least one abrasive diamond cutting member mounted on the periphery of said base core.

7. The saw blade of claim 6, wherein said cutting member engages and is welded to said rim.

8. The saw blade of claim 1, wherein said ceramic material is an oxide-oxide ceramic matrix.

9. A vibration damping diamond tip saw blade comprising:
a base core comprising a circular, planar metal disc, abrasive diamond material located about the circumference of said disc, and a capacitive discharge weld integrating said diamond material and the periphery of said metal disc.

10. The saw blade of claim 10, and heat and abrasion resistant ceramic bonded to and over opposite faces of said disc.

11. The saw blade of claim 10, wherein said disc has plural spaced openings, and
said ceramic extends through at least some of said openings.

12. The saw blade of claim 9, wherein said diamond material comprises multiple arcuate spaced segments.

13. The saw blade of claim 11, wherein said diamond material embraces the circumference of said disc.

14. The saw blade of claim 11, where said some of said openings are generally P shape.
